(19) United States
(12) Patent Application Publication
(10) Pub. No.: US 2024/0180385 A1
(43) Pub. Date: Jun. 6, 2024

(54) SELF-PROPELLED AND SELF-STEERING FLOOR CLEANING APPARATUS, AND FLOOR CLEANING SYSTEM

(71) Applicant: ALFRED KÄRCHER SE & CO. KG, Winnenden (DE)

(72) Inventors: Manuel DRUST, Winnenden (DE); Fedor VLASOV, Winnenden (DE); Heiko HÖNNIGE, Winnenden (DE); Norman KOHLER, Winnenden (DE); Christian HOFNER, Winnenden (DE); Fabian SCHURIG, München (DE); Gereon HINZ, München (DE)

(21) Appl. No.: 18/418,476

(22) Filed: Jan. 22, 2024

Related U.S. Application Data
(63) Continuation of application No. PCT/EP2021/070753, filed on Jul. 23, 2021.

(51) Int. Cl. A47L 11/40; G05D 1/242; G05D 1/648; G05D 105/10; H04N 13/204

(52) U.S. Cl. CPC A47L 11/4011; A47L 11/4002; A47L 11/4061; A47L 11/4091; G05D 1/242; G05D 1/648; A47L 2201/026; A47L 2201/04; G05D 2105/10; H04N 13/204

(57) ABSTRACT

The invention relates to a self-propelled and self-steering floor cleaning apparatus comprising: a running gear for traveling on the floor surface; at least one cleaning device for cleaning the floor surface; a control device; and a sensor device, the control device being formed and configured to locate or navigate the floor cleaning apparatus in an environment depending on at least one signal from the sensor device, the sensor device comprising, on a front side of the floor cleaning apparatus with respect to its forward direction, a first distance measuring unit which is configured as or comprises a stereo camera system and a second distance measuring unit which is configured as or comprises a scanning unit with structured light, wherein viewing areas of the first distance measuring unit and of the second distance measuring unit are directed in the forward direction of the floor cleaning apparatus and overlap, and wherein the second distance measuring unit is located above the first distance measuring unit on the floor cleaning apparatus with respect to a height direction. The invention also relates to a floor cleaning system.

### CROSS-REFERENCE TO RELATED APPLICATIONS

This application is a continuation patent application of international application number PCT/EP2021/070753, filed on Jul. 23, 2021, which is incorporated herein by reference in its entirety and for all purposes.

### FIELD OF THE INVENTION

The present invention relates to a self-propelled and self-steering floor cleaning apparatus, comprising a running gear for traveling on the floor surface, at least one cleaning device for cleaning the floor surface, a control device, and a sensor device, wherein the control device is formed and configured to locate and/or navigate the floor cleaning apparatus in an environment depending on at least one signal from the sensor device.

The invention furthermore relates to a floor cleaning system comprising a floor cleaning apparatus and a docking station.

### BACKGROUND OF THE INVENTION

An autonomous cleaning of the floor surface can be carried out using such a floor cleaning apparatus. For this purpose, the floor cleaning apparatus with the running gear travels over the floor surface under control by the control unit. Dirt can be detached from the floor surface by means of the cleaning device and preferably picked up thereby. For example, a storage container for a cleaning liquid for wetting the floor surface is provided. The cleaning device may, for example, comprise at least one cleaning roller or a disk brush for detaching dirt. A mixture of dirt and cleaning liquid may, for example, be picked up by means of a vacuum strip and transferred into a dirty-liquid container.

It is known that the sensor device may comprise different types of sensor units for detecting the surroundings. These include, for example, cameras, for example RGB cameras, infrared sensor units, ultrasound sensor units, stereo camera systems, and scanning units, which employ, for example, a laser scanner. In practice, it is necessary, with regard to a functional reliability of the floor cleaning apparatus that is to be ensured, to implement as many scanning units as necessary and, on the other hand, as few scanning units as possible in order to keep the technical requirements to a minimum.

It is known to provide sensor units of different types on a self-propelled and self-steering floor cleaning apparatus. For example, this is described in WO 2021/026649 A1, in which on a front side a scanning unit close to the floor and stereo camera systems on the upper side are arranged on the front side of the floor cleaning apparatus.

EP 2 764 812 B1 describes a floor cleaning apparatus which has two stereo camera systems on the front side and a plurality of ultrasound sensor units close to the floor.

An object underlying the present invention is to provide a generic floor cleaning apparatus and a floor cleaning system with which a higher operational reliability can be achieved.

### SUMMARY OF THE INVENTION

In a first aspect of the invention, a self-propelled and self-steering floor cleaning apparatus is provided, comprising a running gear for traveling on the floor surface, at least one cleaning device for cleaning the floor surface, a control device, and a sensor device. The control device is formed and configured to locate and/or navigate the floor cleaning apparatus in an environment depending on at least one signal from the sensor device. The sensor device comprises on a front side of the floor cleaning apparatus, with respect to its forward direction, a first distance measuring unit, which is configured as a stereo camera system, or comprises such a stereo camera system, and a second distance measuring unit, which is configured as a scanning unit with structured light or comprises such a scanning unit. The viewing areas of the first distance measuring unit and of the second distance measuring unit are directed in the forward direction of the floor cleaning apparatus and overlap. The second distance measuring unit is arranged on the floor cleaning apparatus above the first distance measuring unit with respect to a height direction.

In a second aspect of the invention a floor cleaning system is provided. The floor cleaning system comprises a floor cleaning apparatus in accordance with the first aspect, the floor cleaning apparatus comprising at least one connecting element for supplying a consumption component for the floor cleaning apparatus required for carrying out a cleaning task, wherein the at least one connecting element is arranged on the front side. The floor cleaning system further comprises a docking station, comprising at least one connecting element for supplying a consumption component for the floor cleaning apparatus, wherein, in a docking position of the floor cleaning apparatus at the docking station, the at least one connecting element of the floor cleaning apparatus and the at least one connecting element of the docking station couple to one another.

### BRIEF DESCRIPTION OF THE DRAWINGS

The foregoing summary and the following description may be better understood in conjunction with the drawing figures, of which:

FIG. 1: shows a perspective representation of the floor cleaning apparatus in accordance with the invention in a preferred embodiment;

FIG. 2: shows a front view of the floor cleaning apparatus from FIG. 1;

FIG. 3: shows an enlarged view of detail A in FIG. 2;

FIG. 4: shows a perspective representation of the floor cleaning apparatus from FIG. 1 with two viewing areas of distance measuring units;

FIG. 5: shows a perspective representation of the floor cleaning apparatus from FIG. 1 with two viewing areas of further distance measuring units;

FIG. 6: shows a plan view of the floor cleaning apparatus from FIG. 1, a lane and four viewing areas of distance measuring units;

FIG. 7: shows a representation in the viewing direction of arrow 7 in FIG. 6, wherein the floor cleaning apparatus is shown from the left and in addition viewing planes of scanning units are shown;

FIG. 8: shows a plan view of the floor cleaning apparatus in which viewing areas of the scanning units are shown;

FIG. 9: shows a plan view of the floor cleaning apparatus in which viewing areas of ultrasound measuring units are shown; and

FIG. 10: shows a schematic representation of a floor cleaning system in accordance with the invention, comprising the floor cleaning apparatus and a docking station.

### DETAILED DESCRIPTION OF PREFERRED EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a self-propelled and self-steering floor cleaning apparatus, comprising a running gear for traveling on the floor surface, at least one cleaning device for cleaning the floor surface, a control device, and a sensor device, wherein the control device is formed and configured to locate and/or navigate the floor cleaning apparatus in an environment depending on at least one signal from the sensor device. The sensor device comprises on a front side of the floor cleaning apparatus, with respect to its forward direction, a first distance measuring unit, which is configured as a stereo camera system, or comprises such a stereo camera system, and a second distance measuring unit, which is configured as a scanning unit with structured light or comprises such a scanning unit. The viewing areas of the first distance measuring unit and of the second distance measuring unit are directed in the forward direction of the floor cleaning apparatus and overlap. The second distance measuring unit is arranged on the floor cleaning apparatus above the first distance measuring unit with respect to a height direction.

In the floor cleaning apparatus in accordance with the invention, a scanning unit with structured light and a stereo camera system are provided. The viewing areas of both distance measuring units overlap, wherein this also may be understood to mean an intersection of viewing areas. The control unit can evaluate the information of the two distance measuring units, preferably supplement it and/or check for plausibility. Depth information obtained by means of the scanning unit can preferably be supplemented by information from the stereo camera system, the visual range of which is usually less than that of the scanning unit. Due to the positioning of the scanning unit above the stereo camera system, objects arranged in particular in front of the floor cleaning apparatus in the forward direction can be reliably detected and, for example, the travel path of the floor cleaning apparatus can be controlled on the basis thereof. In addition, for example, structures closer to floor are evaluated via the stereo camera system, and/or the small-scale localization and/or navigation behavior of the floor cleaning apparatus is improved.

Position and orientation information, such as “above,” “below” or the like refer in the present case to proper use of the floor cleaning apparatus. In this use, the floor cleaning apparatus can in particular stand on the floor surface via the running gear defining a contact plane, wherein a plane of the floor surface coincides with the contact plane. In the present case, the floor surface can, for example, be regarded in a non-limiting manner as being oriented horizontally. In the present case, “forward direction” refers in particular to a main movement direction of the floor cleaning apparatus when traveling on the floor surface in the intended use. In the present case, “front side” can in particular include portions of the floor cleaning apparatus which are in a transition region from a front to an upper side of the floor cleaning apparatus. “Height direction” in the present case refers to a direction transverse to, and in particular perpendicular to, the floor surface. It can be provided that a lateral offset exists between components of the floor cleaning apparatus that are spaced apart from one another in the vertical direction.

The scanning unit can be, for example, a laser scanning unit (lidar system) or a radar scanning unit (radar system). A laser scanning unit with structured visible and/or invisible light for detecting objects is preferably used. In this case, for example, a light section method is used in which light is emitted within a predefined plane (viewing plane).

Scanning units with structured light, as mentioned repeatedly below, may, for example as in the present embodiment, be laser scanning units or radar scanning units.

In a preferred embodiment of the invention, the scanning unit is a multi-layer scanning unit which is formed to emit structured light in a plurality of different viewing planes. Structured light can be emitted in a plurality of mutually different planes in order to generate more accurate information about the nature of the surroundings.

For example, it is provided that a viewing plane of the second distance measuring unit is directed obliquely downward onto the floor surface. In this way, irregularities and in particular subtle steps or drop-offs in the floor surface can be reliably detected. A cliff sensor can in particular be formed by the second distance measuring unit. The viewing plane is preferably not overshadowed by the front side of the floor cleaning apparatus, so that objects arranged laterally in the transverse direction transverse to the forward direction can also be detected.

An angle between the floor surface and the viewing plane can be, for example, approximately 20° to 70°, preferably approximately 30° to 60°.

Alternatively or additionally, it can be provided that a viewing plane of the second distance measuring unit is oriented parallel to the floor surface. In this way, objects can preferably also be detected which are arranged not only in the forward direction, but also laterally and preferably behind the floor cleaning apparatus. Preferably, a 360° detection is possible.

When a viewing plane parallel to the floor surface is used, it can be advantageous to position the second distance measuring unit as high as possible in the region of the front side.

It can prove favorable if at least one optical axis of the first distance measuring unit is oriented parallel to the floor surface. In particular, the optical axis of a camera of a camera of the stereo camera system or an axis of a coordinate system defined by the stereo camera system can be regarded as an optical axis.

It can be provided that a viewing plane of the first distance measuring unit forms an angle of approximately +/−30° or less with the floor surface, preferably approximately +/−15° or less, for example +/−5° or less.

In particular, it can be provided that a viewing plane of the first distance measuring unit is oriented parallel to the floor surface or, alternatively, perpendicular to the floor surface. The viewing plane is defined, for example, by the optical axes of two cameras of the stereo camera system.

Due to the orientation parallel to the floor surface, structures of objects which are oriented transverse to, and in particular perpendicular to, the floor surface can be reliably detected. When the viewing plane is oriented perpendicular to the floor surface, structures which are oriented at an angle and in particular parallel to the floor surface can be reliably detected.

A camera having two or more cameras in which directions to object points (length and angle) can be determined by means of triangulation can in particular be regarded as a stereo camera system. A corresponding camera can create an image data set that can be combined to form a stereo image. The cameras can be of different designs. For example, at least one camera can be a TOF (time-of-flight) camera. The cameras can be sensitive in the visible spectrum and/or in the infrared spectrum. The stereo camera system can comprise a projection device for emitting light, for example structured light, into the surroundings in order to improve the measurement result. For example, a dot pattern, a line pattern or a grating pattern is projected into the surroundings. The projection light is preferably in the infrared spectrum, wherein projection light in the visible spectrum also is conceivable.

The stereo camera system can form an optical measuring system in which information about positions of the object points is directly evaluated. Alternatively, it can be provided that signals of the stereo camera system are supplied to the control unit, wherein the evaluation is carried out with the control unit.

It can be favorable if the sensor device comprises a third distance measuring unit on the front side which comprises a viewing area oriented in the forward direction and overlapping with the viewing area of the first distance measuring unit and/or with the viewing area of the second distance measuring unit. Further information about the surroundings can be collected via the third distance measuring unit, wherein the provided information can supplement already existing information and/or can be used for the plausibility check thereof.

The third distance measuring unit is preferably arranged, with respect to the height direction, below the second distance measuring unit and/or above the first distance measuring unit.

It proves to be advantageous if the third distance measuring unit is configured as a stereo camera system.

It can be advantageous if at least one optical axis of the third distance measuring unit is aligned parallel to the floor surface.

It can be provided that a viewing plane of the third distance measuring unit forms an angle of approximately +/−30° or less with the floor surface, preferably approximately +/−15° or less, for example +/−5° or less.

In particular, it can be provided that a viewing plane of the third distance measuring unit is oriented perpendicular to the floor surface or, alternatively, parallel to the floor surface.

Reference is made to the above statements in relation to the optical axis and the viewing plane in conjunction with the first distance measuring unit.

In stereo cameras, it is known that the respective cameras define a stereo base along which they are spaced apart from one another.

In a preferred embodiment of the invention, the first distance measuring unit and the third distance measuring unit each comprise a stereo base, the stereo bases forming an angle relative to one another of 45° or more, preferably 90° or substantially 90°.

Such an embodiment makes it possible, for example, to detect more reliably in particular repetitive structures with a preferred direction. If, for example, a repetitive structure is oriented parallel to the stereo base of one of the distance measuring units (and is repeated transverse to and in particular perpendicular thereto), this structure can be detected not as well with this distance measuring unit. However, the structure can be reliably detected by the further distance measuring unit oriented at an angle. In this way, the information of both distance measuring units can be supplemented and any artifacts that can occur during measurement with a distance measuring unit can be falsified by means of the second distance measuring unit.

In particular, an angle of 90° between the stereo bases proves to be favorable, wherein one stereo base is aligned parallel to the floor surface and the other stereo base being aligned perpendicular to the floor surface. For example, this provides the possibility of reliably detecting vertically elongated objects such as posts, pipes or rails with the horizontally aligned stereo camera system. Horizontally oriented objects, such as barrier gates, edges, barrier tape or the like, can be reliably detected with the vertically oriented distance measuring unit.

It can be provided that the first distance measuring unit and the third distance measuring unit have a T-arrangement or an arrangement of an inverted T in the viewing direction toward the front side.

It can be provided that a viewing plane of the first distance measuring unit or a viewing plane of the third distance measuring unit coincides with a central longitudinal plane of the floor cleaning apparatus.

It can be provided that the viewing plane forms an angle of approximately +/−30° or less with the floor surface with the central longitudinal plane, preferably approximately +/−15° or less, for example +/−5° or less.

The optionally present “third” distance measuring unit was explained above. An optionally present “fourth” distance measuring unit is discussed below. It goes without saying that the terms “third” and “fourth” merely serve to simplify understanding of the present explanations. The two distance measuring units can be provided independently of one another, so that, for example, the distance measuring unit referred to below as “fourth” can be the “third” if the “third” distance measuring unit explained above is not provided.

It can be advantageous if the sensor device comprises a fourth distance measuring unit on the front side which, in relation to the height direction, is arranged below the first distance measuring unit and is configured as a scanning unit with structured light or comprises such a unit, wherein a viewing area of the fourth distance measuring unit overlaps with a viewing area of the first distance measuring unit and/or a viewing area of the second distance measuring unit. The surroundings can in particular be detected with spatial depth via the scanning unit, preferably a laser scanning unit. Information from the further distance measuring units (including the third distance measuring unit, if present) can be supplemented and/or checked for plausibility. The positioning of the scanning unit below the further distance measuring units can prove to be advantageous with regard to a small tolerance chain, because the scanning unit is located close to the running gear. This provides the possibility of detecting preferably relatively valid information about the surroundings. For example, the scanning unit is arranged on a chassis of the floor cleaning apparatus, on which chassis the running gear is also held.

A viewing plane of the fourth distance measuring unit is preferably oriented parallel to the floor surface.

It can be provided that, with respect to the height direction, a distance of the first distance measuring unit from the second distance measuring unit is approximately equal to a distance of the first distance measuring unit from the fourth distance measuring unit. This favors an overlapping of the viewing areas of the first distance measuring unit with the further viewing areas.

The sensor device preferably comprises at least one further distance measuring unit which is configured as or comprises a scanning unit with structured light, in particular a laser scanning unit. The further scanning unit is arranged in particular on a rear side of the floor cleaning apparatus in relation to the forward direction. Additional information about the surroundings of the floor cleaning apparatus can be obtained via the scanning unit at the rear side.

A viewing area of the scanning unit is preferably oriented parallel to the floor surface, wherein the viewing area preferably defining a common viewing plane with the viewing area of the fourth distance measuring unit mentioned above.

The scanning units on the front side and on the rear side are advantageously arranged diametrically opposite one another on the floor cleaning apparatus. Here, for example, it can prove advantageous if a corresponding scanning unit is positioned in a corner region, for example the front scanning unit at the front left and the rear scanning unit at the rear right, or the front scanning unit at the front right, and the rear scanning unit at the rear left.

The viewing areas of the scanning units in combination with one another preferably enable a 360° or substantially 360° all-round monitoring of the floor cleaning apparatus. In this way, a particularly high degree of operational reliability of the floor cleaning apparatus can be achieved.

It can be favorable if the sensor device comprises at least one further distance measuring unit which is arranged on a left side or right side of the floor cleaning apparatus with respect to the forward direction, and comprises a viewing area which is directed toward the left side or to the right side of the floor cleaning apparatus and to the floor surface. Here, it is understood that a distance measuring unit arranged on the left side has a viewing area to the left side and a distance measuring unit arranged on the right side has a viewing area to the right side. Operational reliability can be increased by the at least one further distance measuring unit. Lateral regions of the floor cleaning apparatus can additionally be monitored, which is advantageous in particular in the case of changes in direction of travel to the left or to the right.

Advantageously, two further distance measuring units are provided, once on the left side and once on the right side. The distance measuring units are preferably formed symmetrically relative to one another with respect to a central longitudinal plane of the floor cleaning apparatus.

In a preferred embodiment of the invention, the at least one further distance measuring unit takes the form of a stereo camera system. For example, this provides the possibility of monitoring, in particular, the near region of the floor cleaning apparatus with regard to a high functional safety in the event of changes in the direction of travel.

Remote regions of the floor cleaning apparatus can preferably be monitored with scanning units on the upper side of the front side, at the bottom on the front side and at the bottom on the rear side.

A viewing area of the at least one further distance measuring unit overlaps, for example, with a viewing area of the first distance measuring unit and/or the second distance measuring unit. Furthermore, an overlap can be provided with a visual range of the third and/or fourth and/or the further distance measuring unit on the rear side.

The viewing area of the at least one further distance measuring unit can, for example, intersect a lane of the floor cleaning apparatus on the floor surface. In the “lane,” a region of the floor surface can be provided which results from the projection of the housing of the floor cleaning apparatus onto the floor surface without taking cleaning units, such as a cleaning tool, into account.

The preferred diversity of different sensor units and in particular distance measuring units explained above and the different fields of vision allow for an addition to and/or plausibility check of information such as measurement data and serves to increase the operational reliability of the floor cleaning apparatus. Artifacts such as, for example, ghost points, ghost edges or ghost obstacles can be considerably reduced. The floor cleaning apparatus has a low susceptibility to failure, whereby the cleaning performance can be increased.

For the purpose mentioned above, alternatively or additionally, it is advantageously provided that the sensor device comprises at least one ultrasound measuring unit for emitting ultrasound into the surroundings and receiving ultrasound reflected from the surroundings. Ultrasound makes it possible, for example, to reliably detect objects with low reflectance such as glass.

In particular, it can be provided that an ultrasound measuring unit with an ultrasound sensor emitting in the forward direction is arranged on the front side. For example, ultrasound is radiated substantially parallel to the floor surface. The ultrasound measuring unit is preferably arranged as close as possible to the first distance measuring unit in order to supplement and/or plausibilize the information obtained therefrom.

It can be favorable if at least one ultrasound measuring unit is provided which comprises two ultrasound sensors arranged next to one another. The ultrasound sensors are preferably arranged in a common receptacle on a housing of the floor cleaning apparatus. As a result of the paired arrangement of ultrasound sensors achieved in this way, in practice a better measurement result can be achieved. For example, crosstalk between the ultrasound sensors of the measuring unit is monitored and evaluated. Successful crosstalk provides monitoring to confirm that both ultrasound sensors are working. A failure of an ultrasound sensor can be detected when there is an absence of crosstalk. Due to the arrangement of the ultrasound sensors in pairs, in particular a detection region close to the floor cleaning apparatus can be monitored.

The ultrasound measuring unit can comprise more than two ultrasound sensors, for example three ultrasound sensors, arranged next to one another in order to produce a wider detection region.

The ultrasound measuring units of the floor cleaning apparatus can preferably be controlled separately from one another. In this case, the measuring units can be operated synchronously or separately, for example in a clocked manner.

The measuring units can preferably be controlled depending on movement parameters of the floor cleaning apparatus and/or of the detected surroundings. For example, an actuation takes place depending on a movement speed and/or a movement direction. A targeted control of the ultrasound measuring units can take place, for example, in order to check and/or supplement any information of the further distance measuring units.

It can, for example, prove to be advantageous if ultrasound measuring units are arranged on the front side and/or on a left side and/or on the right side of the floor cleaning apparatus. For example, ultrasound measuring units are arranged on the left and right of the floor cleaning apparatus in the region of front side wall portions, for example close to or on transition regions to the front side. Advantageously, at least one ultrasound measuring unit can be on the rear side and/or in the region of rear side wall portions to the left and right of the floor cleaning apparatus, for example close to or on transition regions to the rear side.

Overall, it is advantageous if a monitoring of the surroundings during forward travel and in the case of changes in direction of travel to the left and right can be monitored via the ultrasound measuring units.

It can prove favorable if emission directions of ultrasound sensors of the at least one ultrasound measuring unit are oriented obliquely upward away from the floor surface. In practice, it has been found that, for example, interference influences can be reduced in this way. An angle between the emission direction of the ultrasound sensors and the floor surface can be, for example, approximately 10° to 40°.

Ultrasound sensors may comprise, for example, a beam-forming element, which is configured to be, for example, conical, for forming the sound field and/or for suppressing interference influences.

In a preferred embodiment, the sensor device may comprise at least one time-of-flight (TOF) distance measuring unit. The TOF distance measuring unit is preferably arranged on the front side and can have a viewing area oriented in the forward direction. The TOF distance measuring unit serves, for example, to detect frontal obstacles, surfaces with low reflectance, and/or drop-offs in the floor surface.

It is favorable if the floor cleaning apparatus comprises at least one connecting element for supplying a consumption component required for carrying out a cleaning task for the floor cleaning apparatus, wherein the at least one connecting element is arranged on the front side. For example, a cleaning liquid and/or electrical energy for a battery of the floor cleaning apparatus can be supplied via the connecting element.

In a preferred embodiment of the invention, the at least one connecting element is arranged in the height direction between the first distance measuring unit and the second distance measuring unit.

It can be provided that at least the first distance measuring unit is arranged in a sensor region arranged on the front side, and that the at least one connecting element is arranged in a connection region on the front side, wherein the sensor region is arranged on the front side offset with respect to the rear relative to the connection region. This facilitates the docking of the floor cleaning apparatus via the at least one connecting element, wherein the distance measuring unit is protected from the rear by the offset.

As mentioned at the outset, the present invention further relates to a floor cleaning system.

The floor cleaning system comprises a floor cleaning apparatus of the type described above, comprising at least one connecting element for supplying a consumption component for the floor cleaning apparatus required for carrying out a cleaning task, wherein the at least one connecting element is arranged on the front side. The floor cleaning system further comprises a docking station, comprising at least one connecting element for supplying a consumption component for the floor cleaning apparatus, wherein, in a docking position of the floor cleaning apparatus at the docking station, the at least one connecting element of the floor cleaning apparatus and the at least one connecting element of the docking station couple to one another.

The advantages already mentioned in connection with the explanation of the floor cleaning apparatus can also be achieved with the floor cleaning system in accordance with the invention. Advantageous embodiments of the floor cleaning system in accordance with the invention result from advantageous embodiments of the floor cleaning apparatus in accordance with the invention. Reference is made to the above statements.

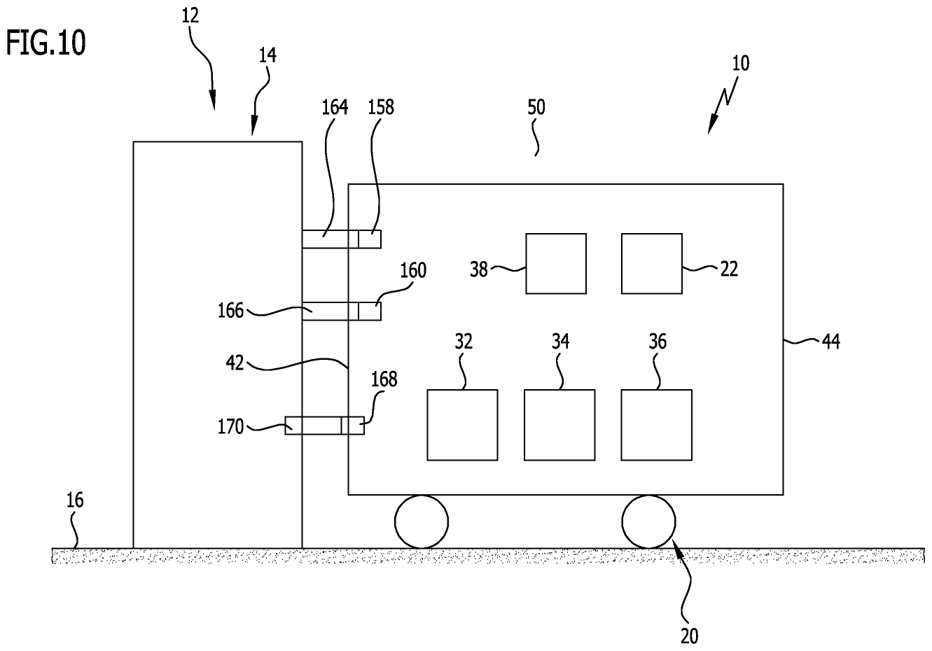

In the drawing, an advantageous embodiment of the floor cleaning apparatus in accordance with the invention, designated as a whole by reference numeral 10, is shown. The floor cleaning apparatus 10 is part of a preferred embodiment of the floor cleaning system 12 in accordance with the invention, which is shown schematically in FIG. 10 and, in addition to the floor cleaning apparatus 10, comprises a docking station 14.

The floor cleaning apparatus 10 is configured to be self-propelled and self-steering and allows autonomous cleaning of a floor surface 16. In particular, the floor cleaning apparatus 10 forms a cleaning robot.

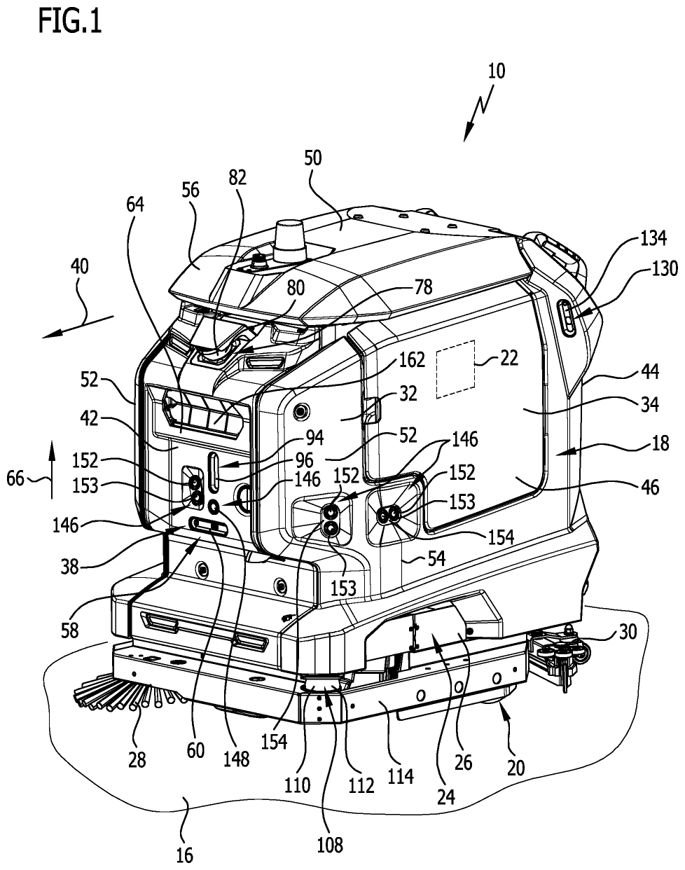

The floor cleaning apparatus 10 comprises a housing 18 with a running gear 20 arranged on an underside for traveling on the floor surface 16. For controlling operation, the floor cleaning apparatus 10 comprises a control device 22 (FIGS. 1 and 10).

In order to clean the floor surface 16, the floor cleaning apparatus 10 comprises a cleaning device 24. The cleaning device 24 comprises a cleaning tool in the form of a floor cleaning head 26 with cleaning rollers (not shown in the drawing), a side brush 28 and a suction strip 30.

Furthermore, a storage container 32 for a cleaning liquid, in particular water, is provided in order to wet the floor surface 16. Dirt is detached from the floor surface 16 with the cleaning tools. The mixture of cleaning liquid and dirt is picked up by means of the suction strip 30 and transferred into a dirty liquid container 34.

For providing electrical energy, the floor cleaning apparatus 10 comprises at least one rechargeable, in particular electrical battery 36.

The floor cleaning apparatus 10 is accordingly a scrubber vacuum. However, the present invention is not limited to this type of floor cleaning apparatus.

For localization and/or navigation within the surroundings, the floor cleaning apparatus 10 comprises a sensor device 38 operatively connected to the control device 22. The sensor device 38 comprises a plurality of sensor units which are explained below.

Depending on at least one signal of the sensor device 38, the control device 22 can control the floor cleaning apparatus 10, for example in order to carry out cleaning tasks. For example, obstacles can be detected, the floor cleaning apparatus 10 can be stopped if necessary, or obstacles can be bypassed.

The plurality of sensor units serves to ensure that the surroundings are monitored as completely as possible. Of particular importance here is a monitoring of the surroundings in a forward direction 40 in which the floor cleaning apparatus 10 can travel on the floor surface 16 during the intended use. The forward direction 40 may, for example, be oriented along a main movement direction during straight-ahead travel. It is also important to monitor the changes in the direction of travel to the left and to the right during forward travel.

Reference is made to the explanations given at the outset in regard to position and orientation specifications. It is assumed below that the floor cleaning apparatus 10 is positioned as intended via the running gear 20 on the floor surface 16, which surface can in particular be oriented horizontally.

In relation to the forward direction 40, the floor cleaning apparatus 10 has a front side 42, a rear side 44, a left side 46, a right side 48 and an upper side 50. Adjacent sides 42 to 50 can define transition regions with one another. For example, transition regions 52 are formed in each case between the left side 46 and the front side 42 and the right side 48 and the front side 42. At the rear, side wall portions 54 adjoin the transition regions 52 to the left and right.

A transition region 56 is formed between the front side 42 and the upper side 50.

Transition regions can be formed by the same housing part or by different housing parts of the housing 18.

The sensor device 38 comprises as a sensor unit a first distance measuring unit 58, which is configured as a stereo camera system 60 (hereinafter stereo camera 60).

The stereo camera 60 is arranged on the front side 42. In this case, the stereo camera 60 is arranged in a sensor region 62 which is offset to the rear with respect to a connection region 64, which will be discussed below, on the front side 42.

With respect to a height direction 66, the stereo camera 60 is positioned in a central region of the floor cleaning apparatus 10, in the present case within a range of approximately 40% to 60% of the height.

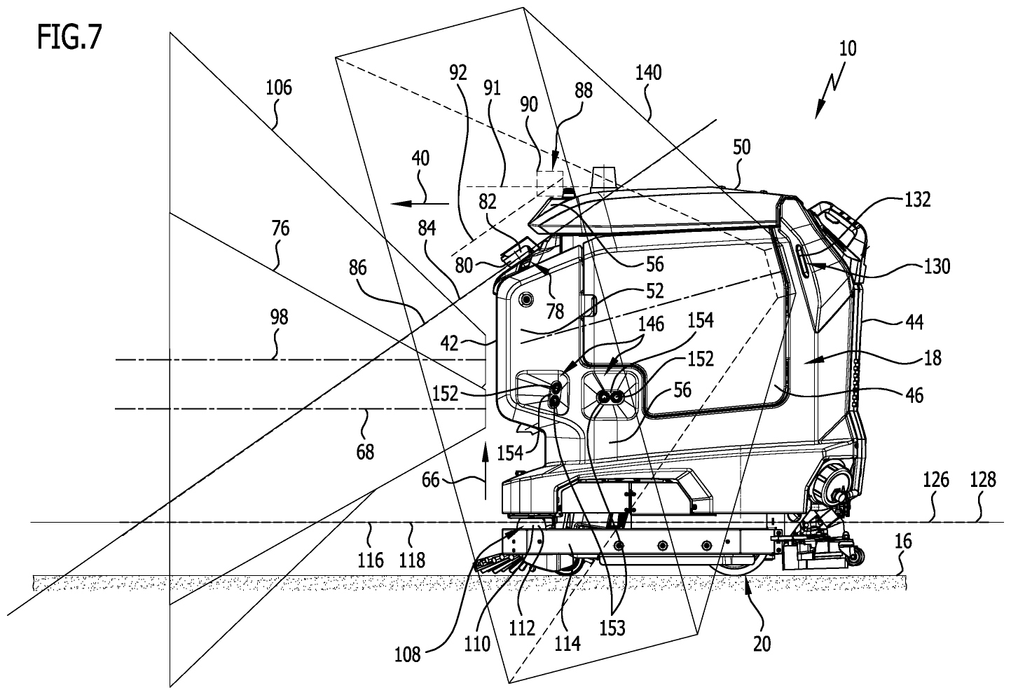

The stereo camera 60 is oriented such that a corresponding optical axis 68 of the cameras 70 of the stereo camera 60 is aligned parallel to the floor surface 16 (FIG. 7). In the present example, a viewing plane 72 of the stereo camera 60 is also oriented parallel to the floor surface 16, wherein the viewing plane 72 is defined by the course of the optical axes 68 of both cameras 70.

The stereo camera 60 further comprises a projection device 74 for projecting structured light (for example a dot pattern, a line pattern or a grating pattern) to improve the measurement result. The stereo camera 60 also has an RGB camera 75 for recording a 2D image.

The stereo camera 60 can be sensitive in the visible range and/or in the infrared range.

The cameras 70 of the stereo camera 60 define a stereo base, which in the present case runs within the viewing plane 72. In the present case, the stereo base is aligned parallel to the floor surface 16.

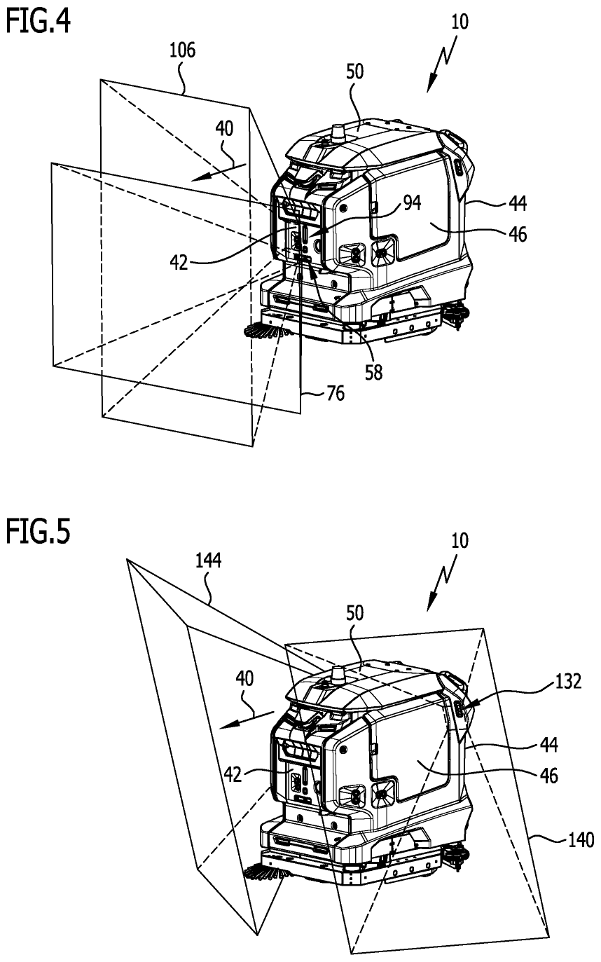

FIGS. 4, 6 and 7 show the viewing area 76 of the stereo camera 60, which area runs in the forward direction 40 and widens toward the front.

At the front side 42, the floor cleaning apparatus 10 comprises a second distance measuring unit 78 which is configured as a scanning unit 80 with structured light, in particular as a lidar system 82. The lidar system 82 is arranged above the stereo camera 60 with respect to the height direction 66, in the present embodiment approximately in the range from 70% to 90% of the height of the floor cleaning apparatus 10.

The lidar system 82 emits structured light in a viewing plane 84 in the forward direction 40. The viewing plane 84 forms a viewing area 86 which overlaps with viewing area 76.

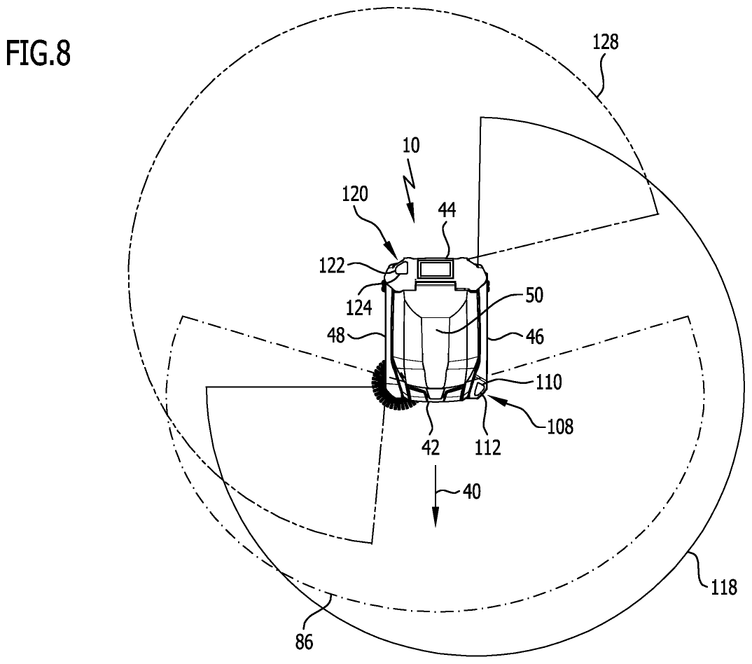

In the present case, viewing area 86 also extends to the left and to the right beyond the floor cleaning apparatus 10 (FIG. 8).

The viewing plane 84 is inclined relative to the floor surface 16 at an angle of approximately 30° to 40° in the present example (FIG. 7).

Objects in the surroundings can be reliably detected by the lidar system 82 due to the possibility of long-range detection. The near region can be checked more precisely by means of the stereo camera 60. Due to the inclination of the viewing area 86 relative to the floor surface 16, the lidar system 82 can in the present case be used in particular for detecting drop-offs and can serve as a cliff sensor.

Alternatively or in addition to the scanning unit 80, the floor cleaning apparatus 10 in accordance with the invention can comprise a distance measuring unit shown schematically in FIG. 7, which unit can be the second distance measuring unit within the meaning of the present disclosure and is assigned the reference numeral 88. The distance measuring unit 88 is in particular a scanning unit 90 configured as a lidar system and specifically a multi-layer scanning unit which is formed to emit structured light in a plurality of different viewing planes 91, 92.

A viewing plane 91 is oriented, for example, parallel to the floor surface 16 and preferably allows monitoring at a circumferential angle of 360° or substantially 360° about the floor cleaning apparatus 10. The viewing plane 92 can, for example, be oriented inclined relative to the floor surface 16 like the viewing plane 84.

It is understood that the scanning unit 90 can have more than only two viewing planes in which structured light is emitted.

In the present case, the sensor device 38 comprises a third distance measuring unit 94 as a further sensor unit, configured as a stereo camera system 96 (hereinafter stereo camera 96). The stereo camera 96 is preferably configured to be identical or functionally identical to the stereo camera 60. In the present case, the stereo camera 96 comprises an optical axis 98, cameras 100 and defines a viewing plane 102. The stereo camera 96 comprises a projection device 104 and an RGB camera 105. It has a viewing area 106 directed in the forward direction 40 which overlaps with viewing areas 76 and 86 and widens toward the front.

The optical axis 98 is aligned parallel to the floor surface 16. In the present example, the viewing plane 102 is oriented perpendicular to the floor surface 16. The viewing plane 102 lies in a central longitudinal plane 103 of the floor cleaning apparatus 10.

The stereo camera 96 comprises a sensor base which runs in the viewing plane 102.

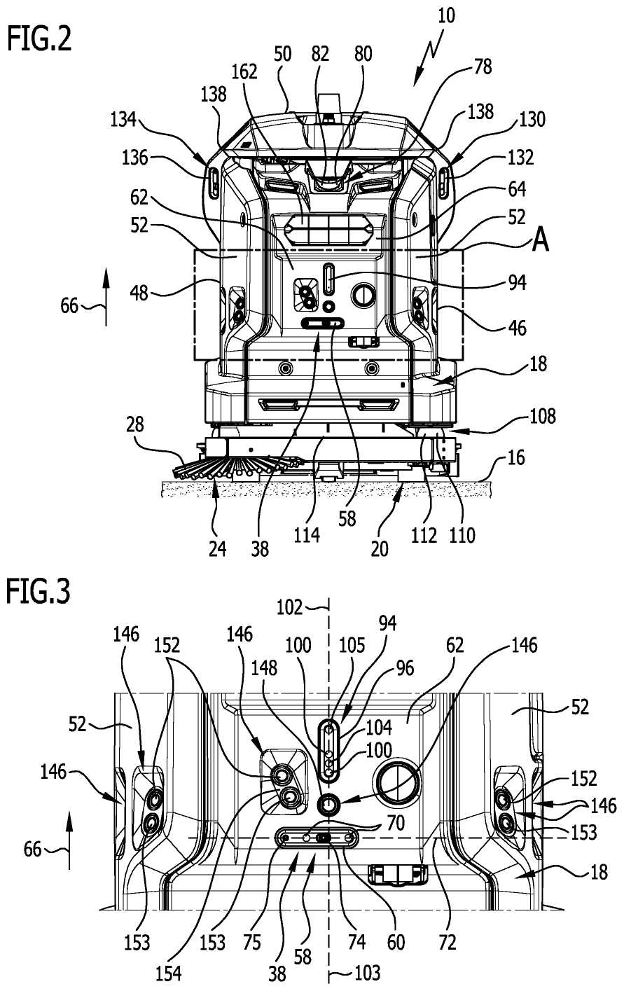

The sensor bases of the stereo cameras 60 and 96 are aligned at an angle to one another, wherein the angle in the present case is 90° (FIGS. 2 and 3).

Such an arrangement of the stereo cameras 60 and 96 is advantageous for better recognizing objects with horizontal and vertical structures. Objects with vertical structures can be better recognized via stereo camera 60 and objects with horizontal structures via the stereo camera 96. Based on the signals of the two stereo cameras 60, 96, it is possible for the control device 38 to exclude any ghost points, ghost edges, and/or ghost obstacles.

In the present case, the stereo camera 96 is arranged in the height direction 66 above the stereo camera 60 and below the lidar system 82. In a plan view of the front side 42, the stereo cameras 60, 96 are arranged with respect to one another in the shape of an inverted T.

For further monitoring of the surroundings, the sensor device 38 comprises a sensor unit in the form of a fourth distance measuring unit 108 configured as a scanning unit 110 with structured light, in particular as a lidar system 112. The lidar system 112 is arranged on the front side 42 below the stereo camera 96, with respect to the height direction 66. As can be seen in particular from FIG. 2, the lidar system 112 is positioned at the front left on the floor cleaning apparatus 10. In this case, the lidar system 112 is arranged close to the floor surface on a chassis 114 on which the running gear 20 is also held, with regard to a small tolerance chain.

The lidar system 112 emits structured light in a viewing plane 116, which in the present case is oriented parallel to the floor surface 16. The lidar system 112 has overall a viewing area 118 which overlaps with viewing areas 76, 86 and 106.

The viewing area 118 extends over a circumferential angle of substantially 270° and allows objects to be detected on the left behind the floor cleaning apparatus 10, on the left next to it and on the right next to it (FIG. 8).

Objects arranged remotely from the floor cleaning apparatus 10 can in particular be detected with the lidar system 112. The near region is additionally monitored by means of the stereo cameras 60 and 96.

In relation to the height direction 66, the stereo camera 60 has approximately the same distances from the lidar systems 112 and 82 in order to be able to monitor the dead space present between the viewing planes 84 and 116 near the front side 42 in the best possible manner (FIG. 7).

The sensor device 38 comprises, as a further sensor unit, a further distance measuring unit 120 configured as a scanning unit 122 with structured light and in particular as lidar system 124. The lidar system 124 emits light in a viewing plane 126, which preferably coincides with viewing plane 116 and is oriented parallel to the floor surface 16.

A viewing area 128 of the lidar system 124 extends over a range of substantially 270° and allows objects to be detected on the right behind the floor cleaning apparatus 10, on the right next to it and on the left behind it (FIG. 8).

The lidar system 124 is arranged diametrically to the lidar system 112 on the floor cleaning apparatus 10 and in the present case is positioned in particular at the rear left and preferably on the chassis 114. FIGS. 2 and 8 each show the corresponding position in dashed lines.

A 360° all-round monitoring of the floor cleaning apparatus 10 can be performed via the two distance measuring units 108 and 120.

The sensor device 38 comprises distance measuring units 130 and 134 as further sensor units, in each case configured as stereo camera system 132 or 136 (hereinafter stereo cameras 132, 136).

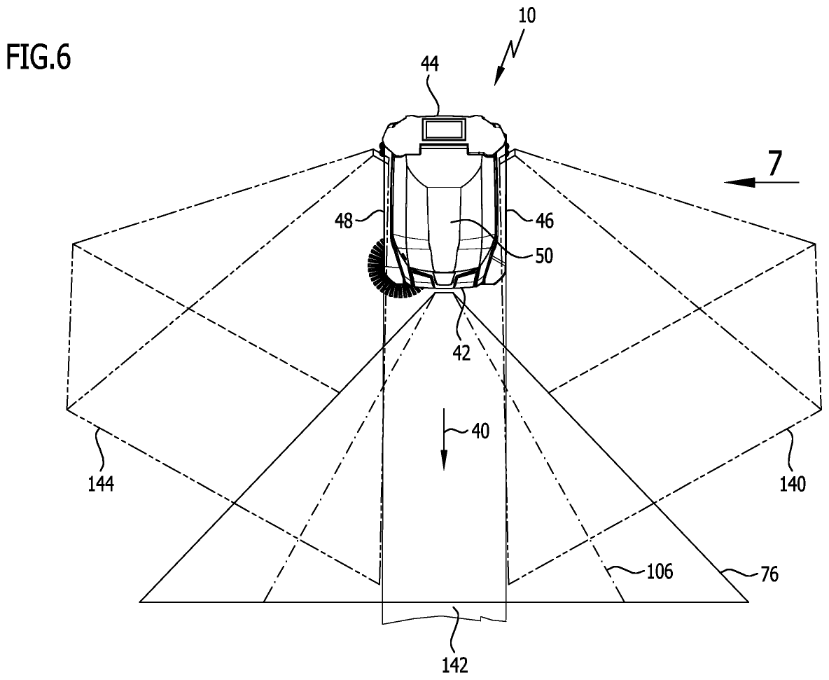

The stereo camera 132 is arranged at the rear left and at the top on the floor cleaning apparatus 10, near a transition region 138 between the left side 46 and the rear side 44. A viewing area 140 is directed toward the left side and onto the floor surface 16 and widens toward the front. The viewing area 140 overlaps with viewing areas 76, 86, 106 and 118 and in the present case intersects a lane 142 of the floor cleaning apparatus 10 (FIG. 6).

The stereo camera 132 serves to monitor the surroundings in particular in the event of changes in the direction of travel to the left.

In a corresponding manner, the stereo camera 136 is arranged at the top rear right-hand side near a transition region 138 between the right-hand side 48 and the rear side 44. The viewing area 144 is directed toward the right side and onto the floor surface 16 and widens toward the front. The viewing area 144 overlaps with viewing areas 76, 86, 106, 118 and 128 and in the present case intersects the lane 142.

The stereo camera 136 serves in particular to monitor the surroundings in the event of changes in the direction of travel to the right.

The stereo cameras 132 and 136 are formed symmetrically with respect to one another with respect to the central longitudinal plane 103.

For further monitoring of the surroundings, the sensor device 38 comprises sensor units in the form of ultrasound measuring units 146. In the present example, a plurality of ultrasound measuring units 146 is provided, which units are arranged in particular on the front side 42, on the transition regions 52 and on the side wall portions 54.

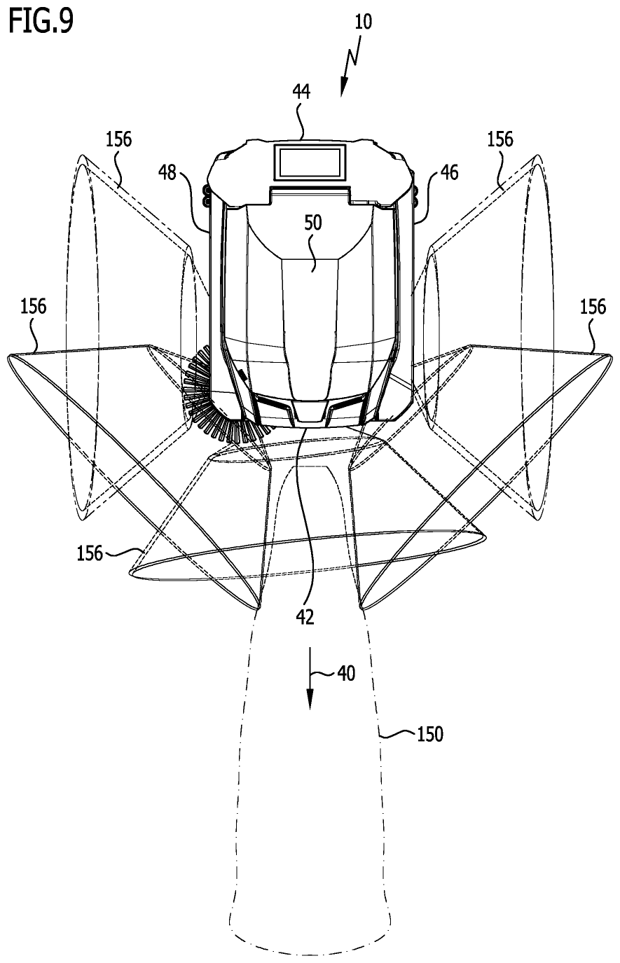

An ultrasound measuring unit 146 is positioned on the front side 42 and is arranged in the present case on the central longitudinal plane 103. Preferably, the ultrasound sensor 148 of this measuring unit 146 is positioned between the stereo cameras 60 and 96 (FIGS. 2 and 3). The ultrasound sensor 148 generates a lobe-shaped ultrasound field 150 (FIG. 9) directed in the forward direction 40.

In the present example, the further measuring units 146 are characterized in particular in that they each comprise ultrasound sensors 152, 153 arranged next to one another in pairs and are arranged in a common receptacle 154. Due to the pairwise arrangement of the ultrasound sensors 152, 153, a failure of one of the ultrasound sensors 152, 153 can be determined via the monitoring of a crosstalk. In addition, it is found in practice that the near region in particular can be better monitored by arranging the ultrasound sensors 152, 153 in pairs.

The corresponding measuring unit 146 with two ultrasound sensors 152, 153 generates an essentially funnel-shaped ultrasound field 156 (FIG. 9).

It can prove favorable if emission directions of the ultrasound sensors 152, 153 are oriented obliquely upward away from the floor surface 16. In practice, it has been found that interference influences can thereby be reduced. An angle between the emission direction and the floor surface can be, for example, approximately 10° to 40°.

A first measuring unit 146 having two ultrasound sensors 152, 153 is arranged on the front side 42. A further measuring unit 146 having two sensors is arranged in each case on the transition regions 52 at the front left and front right. Arranged downstream of the side wall portions 54 on the left side 46 and on the right side 48, respectively, are measuring units 146 having two sensors (of these only one recess receiving the measuring unit 146 is shown in FIGS. 2 and 3).

The measuring units 146 on the side wall portions 54 on the one hand and on the transition regions 52 on the other hand are formed symmetrically relative to one another with respect to the central longitudinal plane 103.

A near region of the floor cleaning apparatus 10 toward the front, to the left and to the right can be reliably monitored via the ultrasound measuring units 146 (FIG. 9).

The floor cleaning system 12 is discussed below. The floor cleaning system 12 comprises the connection region 64 already mentioned. A connecting element 158 for supplying the cleaning liquid and a further connecting element 160 for supplying electrical energy are arranged on the connection region 64. The connecting elements 158, 160 are positioned behind a cover 162.

If the floor cleaning apparatus 10 moves into a docking position on the docking station 14, the connecting elements 158, 160 can couple to corresponding connecting elements 164 or 166 of the docking station 14 (FIG. 10). This allows filling of the storage container 32 and charging of the electrical battery 36. During docking, the cover 162 is preferably opened automatically.

The stereo camera 96 and the ultrasound measuring units 146 on the front side 42 are arranged in the sensor region 62, just like the stereo camera 60, and are offset with respect to the connection region 64. In this way, the sensor units are also protected during docking of the floor cleaning apparatus 10.

The connection region 64 is arranged above the sensor region 62 and below the lidar system 82.

The floor cleaning apparatus 10 comprises a further connecting element 168 which, in the docking position, couples to a corresponding connecting element 170 of the docking station 14. The dirty-liquid container 34 can be emptied in the docking position via the connecting elements 168, 170.

The connecting element 168 is arranged below the sensor region 62 and in the present case above the lidar system 112, with respect to the height direction 66 (FIG. 2).

### LIST OF REFERENCE NUMERALS

10 Floor cleaning apparatus
12 Floor cleaning system
14 Docking station
16 Floor surface
18 Housing
20 Running gear
22 Control device
24 Cleaning device
26 Floor cleaning head
28 Side brushes
30 Suction strip
32 Reservoir
34 Dirty-liquid tank
36 Battery
38 Sensor device
40 Forward direction
42 Front side
44 Rear side
46 Left-hand side
48 Right-hand side
50 Upper side
52 Transition region
54 Side wall portion
56 Transition region
58 First distance measuring unit
60 Stereo camera system
62 Sensor region
64 Connection region
66 Height direction
68 Optical axis
70 Camera
72 Viewing plane
74 Projection device
75 RGB camera
76 Viewing area
78 Second distance measuring unit
80 Scanning unit
82 Lidar system
84 Viewing plane
86 Viewing area
88 Distance measuring unit
90 Scanning unit
91 Viewing plane
92 Viewing plane
94 Third distance measuring unit
96 Stereo camera system
98 Optical axis
100 Camera
102 Viewing plane
103 Central longitudinal plane
104 Projection device
105 RGB camera
106 Viewing area
108 Fourth distance measuring unit
110 Scanning unit
112 Lidar system
114 Chassis
116 Viewing plane
118 Viewing area
120 Distance measuring unit
122 Scanning unit
124 Lidar system
126 Viewing plane
128 Viewing area
130 Distance measuring unit
132 Stereo camera system
134 Distance measuring unit
136 Stereo camera system
138 Transition region
140 Viewing area
142 Lane
144 Viewing area
146 Ultrasound measuring unit
148 Ultrasound sensor
150 Ultrasound field
152 Ultrasound sensor
153 Ultrasound sensor
154 Receptacle
156 Ultrasound field
158 Connecting element
160 Connecting element
162 Cover
164 Connecting element
166 Connecting element
168 Connecting element
170 Connecting element

What is claimed is:

1. Self-propelled and self-steering floor cleaning apparatus comprising a running gear for traveling on the floor surface, at least one cleaning device for cleaning the floor surface, a control device, and a sensor device, wherein the control device is formed and configured to locate and/or navigate the floor cleaning apparatus in an environment depending on at least one signal from the sensor device, wherein the sensor device comprises on a front side of the floor cleaning apparatus with respect to its forward direction, a first distance measuring unit, which is configured as or comprises a stereo camera system, and a second distance measuring unit, which is configured as or comprises a scanning unit with structured light, wherein viewing areas of the first distance measuring unit and of the second distance measuring unit are directed in the forward direction of the floor cleaning apparatus and overlap, and wherein the second distance measuring unit is arranged with respect to a height direction above the first distance measuring unit on the floor cleaning apparatus.

2. Floor cleaning apparatus in accordance with claim 1, wherein the scanning unit is a laser scanning unit or a radar scanning unit.

3. Floor cleaning apparatus in accordance with claim 1, wherein the scanning unit is a multi-layer scanning unit which is formed to emit structured light in a plurality of different viewing planes.

4. Floor cleaning apparatus in accordance with claim 1, wherein a viewing plane of the second distance measuring unit is directed obliquely downward onto the floor surface and/or wherein a viewing plane of the second distance measuring unit is oriented parallel to the floor surface.

5. Floor cleaning apparatus in accordance with claim 1, wherein at least one optical axis of the first distance measuring unit is aligned parallel to the floor surface and/or wherein a viewing plane of the first distance measuring unit is oriented parallel to the floor surface or perpendicular to the floor surface.

6. Floor cleaning apparatus in accordance with claim 1, wherein the sensor device comprises a third distance measuring unit on the front side which comprises a viewing area oriented in the forward direction and overlapping with the viewing area of the first distance measuring unit and/or with the viewing area of the second distance measuring unit.

7. Floor cleaning apparatus in accordance with claim 6, wherein the third distance measuring unit is arranged, with respect to the height direction, below the second distance measuring unit and/or above the first distance measuring unit.

8. Floor cleaning apparatus in accordance with claim 6, wherein the third distance measuring unit is configured as a stereo camera system.

9. Floor cleaning apparatus in accordance with claim 6, wherein at least one optical axis of the third distance measuring unit is aligned parallel to the floor surface and/or wherein a viewing plane of the third distance measuring unit is oriented perpendicular to the floor surface or parallel to the floor surface.

10. Floor cleaning apparatus in accordance with claim 6, wherein the first distance measuring unit and the third distance measuring unit each comprise a stereo base, wherein the stereo bases forms an angle relative to one another of 45° or more, 90° or substantially 90°.

11. Floor cleaning apparatus in accordance with claim 6, wherein the first distance measuring unit and the third distance measuring unit have a T-arrangement or an arrangement of an inverted T in the viewing direction toward the front side.

12. Floor cleaning apparatus in accordance with claim 6, wherein a viewing plane of the first distance measuring unit or a viewing plane of the third distance measuring unit coincides with a central longitudinal plane of the floor cleaning apparatus.

13. Floor cleaning apparatus in accordance with claim 6, wherein the sensor device on the front side comprises a fourth distance measuring unit, which fourth distance measuring unit is arranged below the first distance measuring unit with respect to the height direction, and is configured as or comprises a scanning unit with structured light, wherein a viewing area of the fourth distance measuring unit overlaps with a viewing area of the first distance measuring unit and/or a viewing area of the second distance measuring unit.

14. Floor cleaning apparatus in accordance with claim 13, wherein, with respect to the height direction, a distance of the first distance measuring unit from the second distance measuring unit is approximately equal to a distance of the first distance measuring unit from the fourth distance measuring unit.

15. Floor cleaning apparatus in accordance with claim 13, wherein the sensor device comprises at least one further distance measuring unit which is configured as or comprises a scanning unit with structured light, and which is arranged on a rear side of the floor cleaning apparatus with respect to the forward direction.

16. Floor cleaning apparatus in accordance with claim 15, wherein the scanning units are arranged on the front side and the rear side diametrically opposite one another on the floor cleaning apparatus, and/or that viewing areas of the scanning units enable a 360° or substantially 360° all-round monitoring of the floor cleaning apparatus.

17. Floor cleaning apparatus in accordance with claim 1, wherein the sensor device comprises at least one further distance measuring unit which is arranged on the left side or right side of the floor cleaning apparatus with respect to the forward direction and comprises a viewing area which is directed to the left side or to the right side of the floor cleaning apparatus and to the floor surface.

18. Floor cleaning apparatus in accordance with claim 17, wherein two further distance measuring units are provided.

19. Floor cleaning apparatus in accordance with claim 18, wherein the two further distance measuring units are formed symmetrically relative to one another with respect to a central longitudinal plane of the floor cleaning apparatus.

20. Floor cleaning apparatus in accordance with claim 17, wherein the at least one further distance measuring unit is formed as a stereo camera system.

21. Floor cleaning apparatus in accordance with claim 17, wherein a viewing area of the at least one further distance measuring unit overlaps with a viewing area of the first distance measuring unit and/or the second distance measuring unit.

22. Floor cleaning apparatus in accordance with claim 1, wherein the sensor device comprises at least one ultrasound measuring unit.

23. Floor cleaning apparatus in accordance with claim 22, wherein an ultrasound measuring unit with an ultrasound sensor emitting in the forward direction is arranged on the front side.

24. Floor cleaning apparatus in accordance with claim 22, wherein at least one ultrasound measuring unit is provided which comprises two ultrasound sensors arranged next to one another.

25. Floor cleaning apparatus in accordance with claim 22, wherein ultrasound measuring units are arranged on the front side and/or on a left side and/or on the right side of the floor cleaning apparatus, in the region of front side wall portions of the floor cleaning apparatus and/or on a rear side of the floor cleaning apparatus.

26. Floor cleaning apparatus in accordance with claim 22, wherein emission directions of ultrasound sensors of the at least one ultrasound measuring unit are oriented obliquely upward away from the floor surface.

27. Floor cleaning apparatus in accordance with claim 1, wherein the sensor device comprises at least one time-of-flight (TOF) distance measuring unit which is arranged on the front side and has a viewing area oriented in the forward direction.

28. Floor cleaning apparatus in accordance with claim 1, wherein the floor cleaning apparatus comprises at least one connecting element for supplying a consumption component for the floor cleaning apparatus required for carrying out a cleaning task, wherein the at least one connecting element is arranged on the front side.

29. Floor cleaning apparatus in accordance with claim 28, wherein the at least one connecting element is arranged in the height direction between the first distance measuring unit and the second distance measuring unit.

30. Floor cleaning apparatus in accordance with claim 28, wherein at least the first distance measuring unit is arranged in a sensor region arranged on the front side, and wherein the at least one connecting element is arranged on the front side in a connection region, wherein the sensor region is arranged offset to the rear relative to the connection region on the front side.

31. Floor cleaning system comprising a floor cleaning apparatus in accordance with claim 28, and a docking station for this purpose, comprising at least one connecting element for supplying a consumption component for the floor cleaning apparatus, wherein, in a docking position of the floor cleaning apparatus at the docking station, the at least one connecting element of the floor cleaning apparatus and the at least one connecting element of the docking station couple to one another.
